(19) United States
(12) Patent Application Publication
(10) Pub. No.: US 2016/0243479 A1
(43) Pub. Date: Aug. 25, 2016

(54) HIGH PERFORMANCE PRE-CLEANER AND METHOD

(71) Applicant: DONALDSON COMPANY, INC., Minneapolis, MN (US)

(72) Inventors: Paul GOSSEZ, Mont Saint Guibert (BE); Massimo MOVIA, Enemonzo (UD) (IT)

(21) Appl. No.: 15/030,828

(22) PCT Filed: Oct. 22, 2014
(86) PCT No.: PCT/US2014/061800

§ 371 Date: Apr. 20, 2016

Related U.S. Application Data
(60) Provisional application No. 61/895,682, filed on Oct. 25, 2013.

(51) Int. Cl. B01D 45/16; F02M 35/02; F02M 35/022

(52) U.S. Cl. CPC B01D 45/16; F02M 35/0223; F02M 35/0215

(57) ABSTRACT

A pre-cleaner tube assembly includes an inlet tube having an inlet tube wall surrounding an interior volume and first and second open, opposite ends. A vane arrangement is oriented within the inlet tube wall adjacent to the first open end. The inlet tube wall defines a slot adjacent to the second open end. An outlet tube has an outlet tube wall surrounding an interior volume, an open entrance end, and an opposite open exit end. The outlet tube wall has an exterior and an interior. The exterior of the outlet tube wall has a ramp extending upward as the ramp extends from a region adjacent to the entrance end toward a remaining portion of the outlet tube wall. The outlet tube is oriented in the inlet tube wall interior volume such that the entrance end and over 50% of a length of the outlet wall is within the inlet tube wall interior volume.

This application is being filed on 22 Oct. 2014, as a PCT International Patent application and claims priority to U.S. Provisional patent application Ser. No. 61/895,682, filed Oct. 25, 2014.

### TECHNICAL FIELD

This disclosure is directed to pre-cleaner tube assemblies for use in inertial type pre-cleaners, and methods of use.

### BACKGROUND

Pre-cleaners using vortex separators are known. Usually, these types of pre-cleaners are used upstream of a regular engine air cleaner, frequently in dusty or off-road environments. Improvements over prior art pre-cleaners are desired. The improvements include low cost, low restriction, high performance, and low risk of plugging.

### SUMMARY

In one aspect, a pre-cleaner tube assembly is provided. The pre-cleaner tube assembly includes an inlet tube having an inlet tube wall surrounding an interior volume and first and second open, opposite ends. A vane arrangement is oriented within the inlet tube wall adjacent to the first open end. The inlet tube wall defines a slot adjacent to the second open end. An outlet tube has an outlet tube wall surrounding an interior volume, an open entrance end, and an opposite open exit end. The outlet tube wall has an exterior and an interior. The exterior of the outlet tube wall has a ramp extending upward as the ramp extends from a region adjacent to the entrance end toward a remaining portion of the outlet tube wall. The outlet tube is oriented in the inlet tube wall interior volume such that the entrance end and over 50% of a length of the outlet wall is within the inlet tube wall interior volume.

The exit end of the outlet tube can be exterior of the inlet tube wall.

The ramp can be on a radius of 1.5-3 mm.

The ramp can be on a radius of 2-2.5 mm.

The entrance end of the outlet tube can be circular with an internal radius and a central axis. A first distance is defined between the central axis and a radial outermost point of the ramp. A ratio of the first distance to the internal radius of the entrance end is between 1.5 and 1.3.

The ratio of the first distance to the internal radius of the entrance end is about 1.2.

At least 75% of a length of the outlet tube wall is within the inlet tube wall interior volume.

The second end of the inlet tube can be engaged against the exterior of the outlet tube wall and closer to the exit end of the outlet tube than the entrance end of the outlet tube.

The slot in the inlet tube wall can be an open slot extending from the second open end.

The slot in the inlet tube wall can extend a length of at least 50% of the length of the outlet tube.

The exit end of the outlet tube can have a diameter greater than a diameter of the entrance end of the outlet tube.

The inlet tube wall can have a constant outer diameter.

A pre-cleaner is provided having a housing with an air inlet, an opposite air outlet, a debris outlet, and an interior. A plurality of pre-cleaner tube assemblies as characterized above is operably oriented in the interior of the housing such that the first ends of the inlet tubes are at the air inlet of the housing; the exit ends of the outlet tube are at the air outlet of the housing; and of the slots are oriented toward the debris outlet.

The housing can include a cover that is a single molded piece as the inlet tubes.

The housing can include a housing body that is a single molded piece as the outlet tubes.

A method of using the pre-cleaner as characterized above can include directing air flow into the air inlet of the housing and into the first end of the inlet tubes; causing the air flowing into the first end of the inlet tubes to swirl with the vane arrangement; allowing centrifugal forces to direct at least some debris in a direction toward an inner surface of the inlet tube wall; allowing the air to flow through the outlet tube and out of the air outlet of the housing; and allowing at least some of the debris to exit the inlet tube through the slot and fall into the debris outlet of the housing.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the forgoing general description and the following detailed description are explanatory only, and are not restrictive of the claimed invention.

### BRIEF DESCRIPTION OF THE DRAWINGS

FIG. 1 is a front view of a pre-cleaner showing the air outlet and using pre-cleaner tube assemblies, constructed in accordance with principles of this disclosure;

FIG. 2 is a rear view of the pre-cleaner of FIG. 1;

FIG. 3 is a cross-sectional view of the pre-cleaner of FIGS. 1 and 2, the cross-section being taken along the line 3-3 of FIG. 2;

FIG. 4 is an exploded perspective view of the pre-cleaner of FIGS. 1-3;

FIG. 5 is a perspective view of one of the pre-cleaner tube assemblies used in the pre-cleaner of FIGS. 1-4, constructed in accordance with principles of this disclosure;

FIG. 6 is an end view of the pre-cleaner tube assembly of FIG. 5;

FIG. 7 is a cross-sectional view of the pre-cleaner tube assembly of FIGS. 5 and 6, the cross-section being taken along the line 7-7 of FIG. 6;

FIG. 8 is a perspective view of an outlet tube used in the pre-cleaner tube assembly of FIGS. 5-7;

FIG. 9 is an end view of the outlet tube of FIG. 8;

FIG. 10 is a side view of the outlet tube of FIGS. 8 and 9:

FIG. 11 is a cross-sectional view of the outlet tube of FIGS. 8-10, the cross-section being taken along the line 11-11 of FIG. 9;

FIG. 12 is an enlarged cross-sectional view of a portion of the outlet tube of FIG. 11;

FIG. 13 is a perspective view of the inlet tube used in the pre-cleaner tube assembly of FIGS. 5-7;

FIG. 14 is a cross-sectional view of the inlet tube of FIG. 13;

FIG. 15 is a perspective view of another embodiment of a portion of a pre-cleaner housing, the portion depicted being a cover holding a plurality of inlet tubes, constructed in accordance with principles of this disclosure;

FIG. 16 is a front view of the cover of FIG. 15;

FIG. 17 is a cross-sectional view of the cover of FIG. 16, the cross-section being taken along the line 17-17 of FIG. 16;

FIG. 18 is a perspective view of another portion of the pre-cleaner housing used with the cover of FIGS. 15-17, the portion depicted being a housing body having a plurality of outlet tubes, constructed in accordance with principles of this disclosure;

FIG. 19 is a front view of the housing body of FIG. 18;

FIG. 20 is a cross-sectional view of the housing body of FIGS. 18 and 19, the cross-section being taken along the line 20-20 of FIG. 19; and

FIG. 21 is an enlarged cross-sectional view of one of the outlet tubes depicted in FIG. 20.

### DETAILED DESCRIPTION

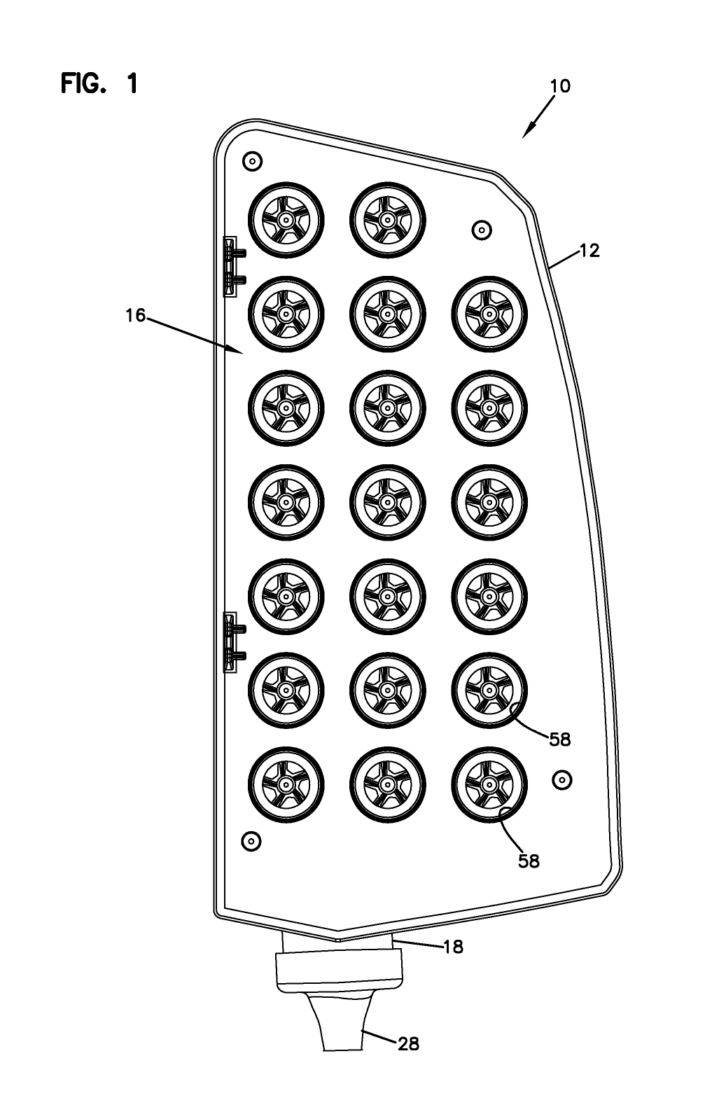

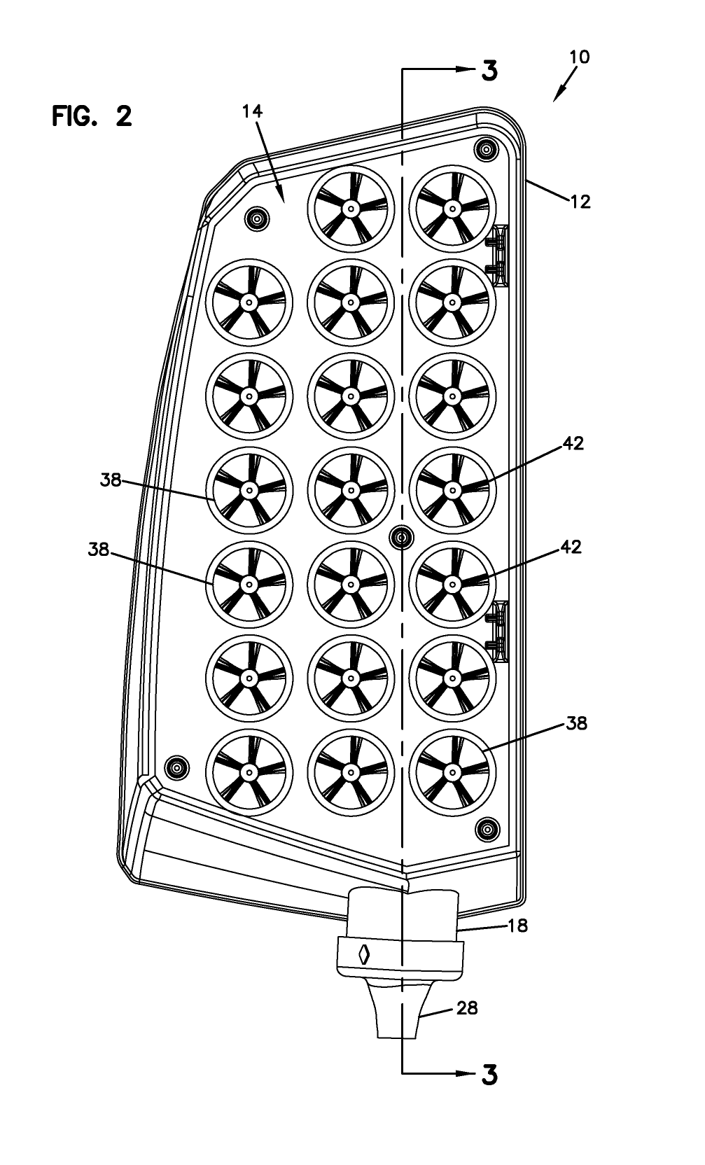

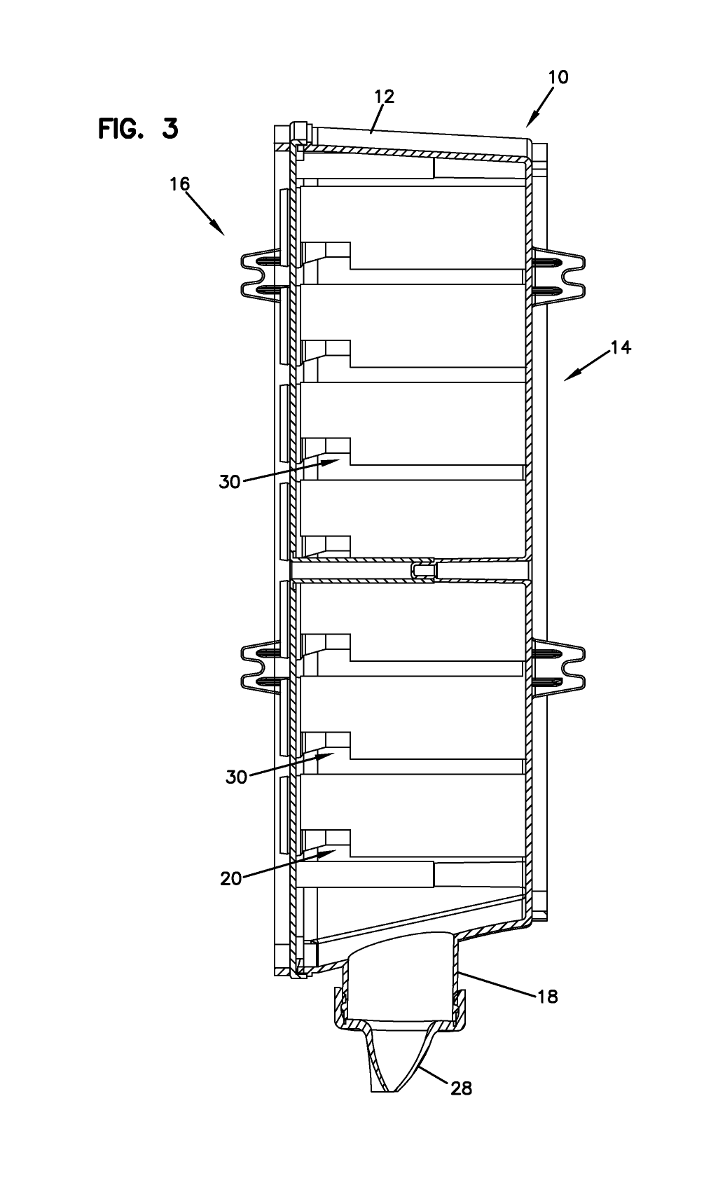

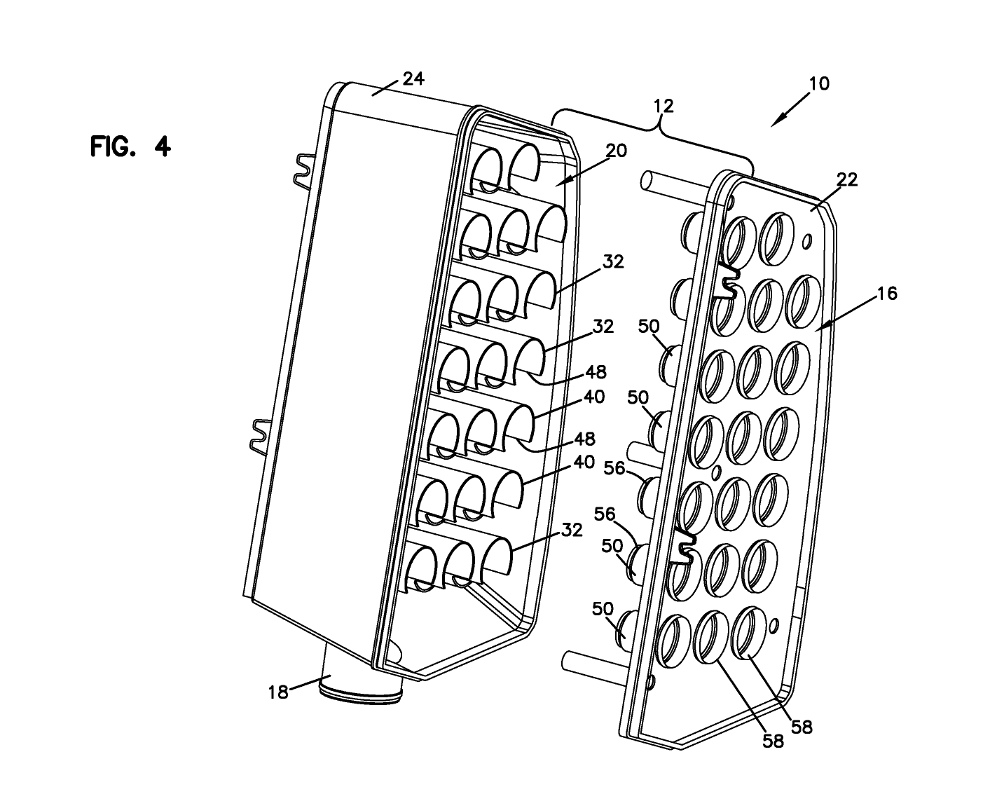

FIGS. 1-4 show an embodiment of a pre-cleaner 10 constructed in accordance with principles of this disclosure. The pre-cleaner 10 includes a housing 12 having an air inlet 14 (FIG. 2), and air outlet 16 (FIG. 1) a debris outlet 18, and an interior 20 (FIGS. 3 and 4). The air inlet 14 and air outlet 16 are at opposite sides of the housing 12.

In FIG. 4, in this embodiment, the housing 12 has a cover 22, which generally defines the air outlet 16 of the housing 12. The housing 12 also includes a housing body 24. The cover 22 operably attaches and is securable to the housing body 24.

The debris outlet 18 is illustrated as a tube 26 extending from the housing body 24. The tube 26 of the debris outlet 18 is in open communication with the interior 20 of the housing 12. In FIGS. 1-3, in preferred embodiments, the tube 26 of the debris outlet 18 is closed with an evacuation valve 28, which will selectively open when there is sufficient debris collected in the tube 26 of the debris outlet 18.

In the interior 20 of the housing 12, the pre-cleaner 10 includes a plurality of pre-cleaner tube assemblies 30. The pre-cleaner tube assemblies 30 are operably oriented in the interior 20 so that air flowing through the air inlet 14 of the housing 12 flows through the pre-cleaner tube assemblies 30, and then the air exiting the housing 12 through the air outlet 16 will exit the pre-cleaner tube assemblies 30. The pre-cleaner tube assemblies 30 remove at least some debris from the air and cause the debris to fall into the debris outlet 18. More details on operation are described further below, after example pre-cleaner tube assemblies 30 are described.

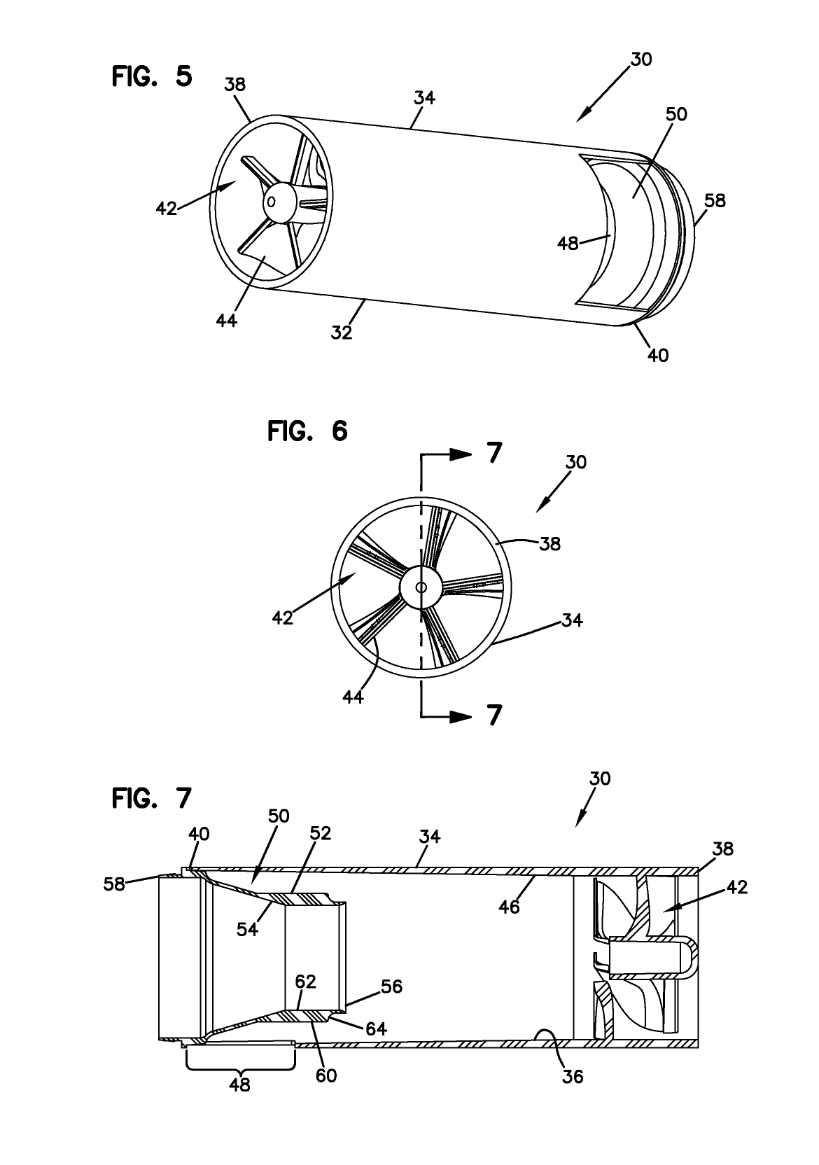

Turning now to FIGS. 5-7, the pre-cleaner tube assembly 30 used in the pre-cleaner 10 is illustrated. The pre-cleaner tube assembly 30 includes an inlet tube 32. The inlet tube 32 has an inlet tube wall 34 surrounding an interior volume 36. The inlet tube 32 has first open end 38 and second open end 40 at opposite ends of the inlet tube 32.

A vane arrangement 42 is oriented within the inlet tube wall 34 adjacent to the first open end 38. The vane arrangement 42 includes a plurality of vanes 44. The vanes 44 are constructed and arranged to induce swirling or a circular flow to air entering the inlet tube 32 through the first end 38. When the air swirls around, centrifugal force causes debris in the swirling air to be directed toward and in some cases against an inner surface 46 of the inlet tube wall 34. Some of that debris then exits the inlet tube 32 through a slot 48. The slot 48 is defined by the inlet tube wall 34, and it is adjacent to the second open end 40.

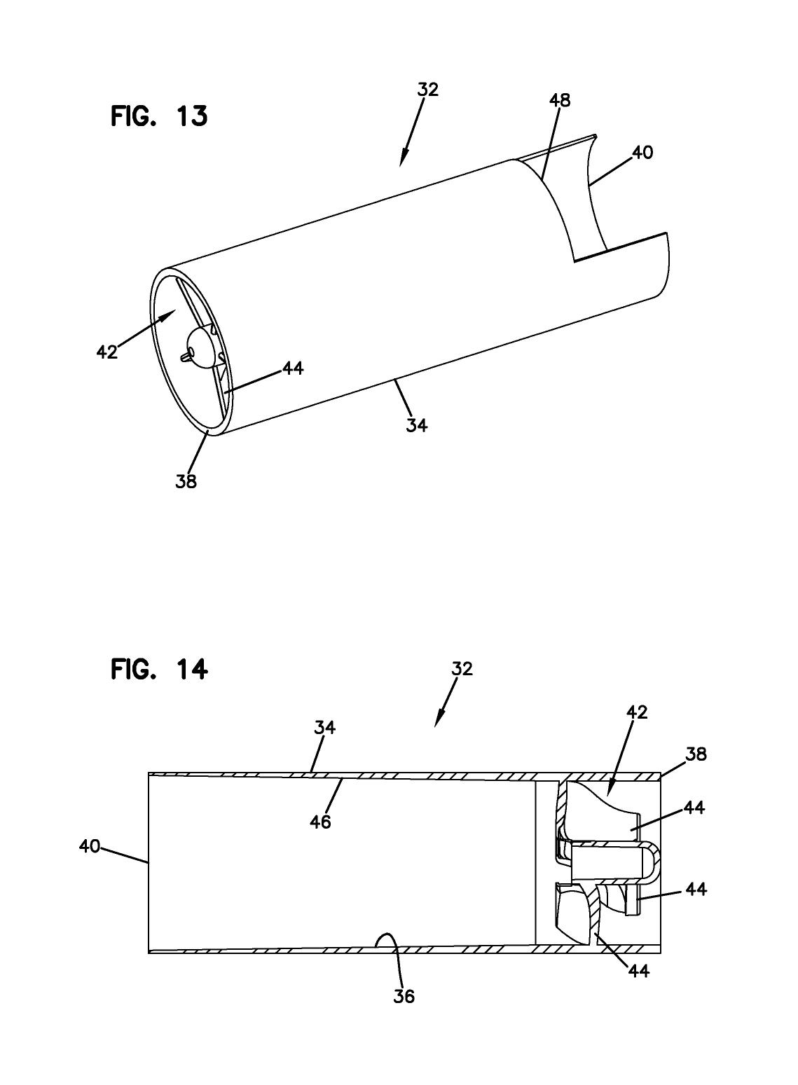

In the examples shown in FIGS. 5 and 13, the slot 48 is an open slot extending from the second open end 40. The slot 48 is further defined by being a circumferential cutout or circumferential void in the inlet tube wall 34. The circumferential void extends across an arc of at least 30 degrees, in some cases at least 45 degrees, and in some cases at least 90 degrees. An axial length of the slot 48 measured as a percentage of an overall length of the inlet tube wall 34 between the first end 38 and second end 40 is at least 10%, no greater than 40%, and typically 15-25%.

In the example embodiment shown, the inlet tube wall 34 has a constant outer diameter, such that it forms a straight inlet tube 32.

The pre-cleaner tube assembly 30 further includes an outlet tube 50. The outlet tube 50 has an outlet tube wall 52 surrounding an interior volume 54. The outlet tube wall 52 has opposite ends, one end being an open entrance end 56, and the opposite being an open exit end 58.

As can be seen in FIG. 7, the outlet tube 50 is at least partially oriented in the inlet tube interior volume 36. In the example shown, the outlet tube 50 is oriented in the interior volume 36 of the inlet tube so that the entrance end 56 and over 50% of a length of the outlet tube wall 52 is within the inlet tube wall interior volume 36.

Preferably, and as shown in FIG. 7, the exit end 58 of the outlet tube 50 is exterior of the inlet tube wall 34.

In many preferred arrangements, at least 75% of a length of the outlet tube wall 52 is within the inlet tube wall interior volume 36.

Still in reference to FIG. 7, the second end 40 of the inlet tube 32 is engaged against the exterior 60 of the outlet tube wall 52 at a location that is closer to the exit end 58 of the outlet tube 50 than the entrance end 56 of the outlet tube 50. In the example shown, the second end 40 is within 20%, typically within 15%, of the exit end 58 as compared to the overall length of the outlet tube 50.

When the outlet tube 50 is operably assembled within the interior volume 36 of the inlet tube 32, the slot 48 in the inlet tube wall 34 extends the length that is at least 50% of the overall length (between entrance end 56 and exit end 58) of the outlet tube 58. The slot 48 does not extend as far as the entrance end 56.

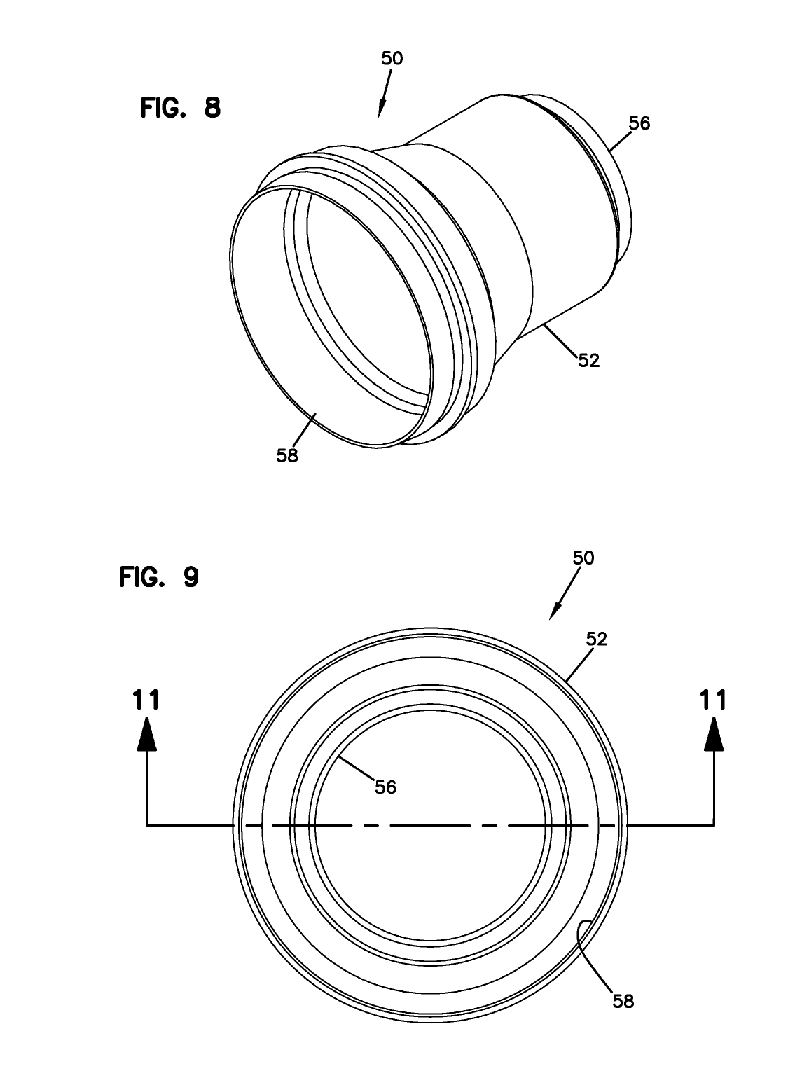

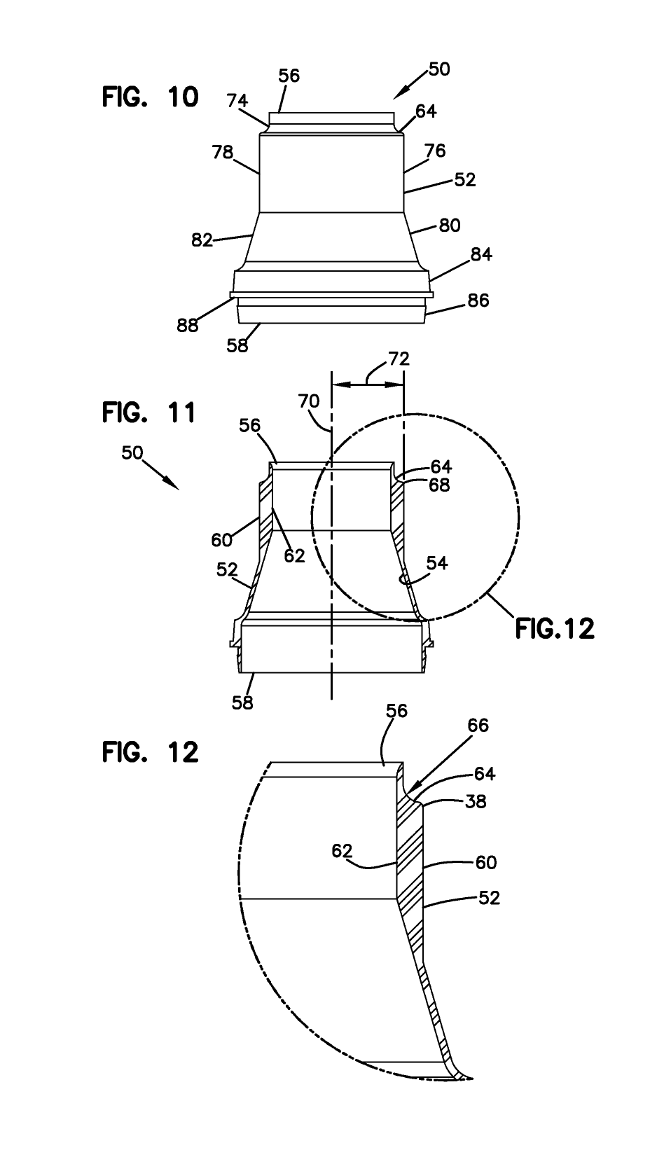

Attention is directed to FIGS. 8-12, which illustrate various views of one example outlet tube 50. The outlet tube wall 52 has exterior 60 and an opposite interior 62. The exterior 60 of the outlet tube wall 52 includes a ramp 64 (FIGS. 10-12).

The ramp 64 extends upward as the ramp 64 extends from a region adjacent the entrance end 56 toward a remaining portion of the outlet tube wall 52. The ramp 64 helps to push large particles in a direction toward the inner surface 46 of the inlet tube 32. When comparing pre-cleaner tube assemblies 30 that do not have a ramp 64 to pre-cleaner tube assemblies that do have a ramp 64, it has been found that a greater percentage of water and particulate matter is removed from the air.

Many embodiments can be made. In this embodiment, the ramp 64 is on a radius of curvature at 66 (FIG. 12) of between 1.5-3 mm. In many preferred systems, the ramp 64 is on a radius of 2-2.5 mm.

Still in reference to FIG. 12, the ramp 64 includes a radial outermost point 68. This radial outermost point 68 is on radius of curvature, extending in an opposite curvature as radius 66, of less than 1 mm, for example between 0.7 and 0.8 mm.

The entrance end 56 of the outlet tube 50 can be circular having an internal radius and a central longitudinal axis 70. There is a first distance 72 in a radial direction between the outermost point 68 of the ramp 64 and the central axis 70. A ratio of the first distance 72 to the internal radius of the entrance end 56 is between 1.1 and 1.3. In many preferred systems, the ratio of the first distance 72 to the internal radius of the entrance end is about 1.2.

As can be seen in FIGS. 8-11, in the example embodiment illustrated, the exit end 58 of the outlet tube 50 has a diameter that is greater than a diameter of the entrance end 56 of the outlet tube 50.

In the example embodiment illustrated and in reference now to FIG. 10, the outlet tube 50 includes a ramp section 74, on which the ramp 64 is located, which extends from the entrance end 56 to the point 68. The ramp section 74 is less than 15% of the overall length of the outlet tube 50.

Immediately adjacent to the ramp section 74 is a second section 76. The second section 76 has a relatively straight outer wall 78. The second section 76 has a length as an overall percentage of the overall length of the outlet tube 50 of between 20-35%.

Immediately adjacent the second section 76 and at an opposite end as the ramp section 74 is a diverging section 80. The diverging section 80 diverges radially outwardly as its wall 82 extends from the second section 76 in a direction toward the exit end 58. The length of the diverging section 80 as a percentage of the overall length of the outlet tube 80 can be between 40-60%.

Adjacent to the diverging section 80 and on an opposite side as the second section 76 is a third section 84. The third section 84 is a relatively straight walled section with a length as a percentage of the overall length of less than 15%. The third section 84, in the embodiment shown, defines the outermost outer diameter of the outlet tube 50.

Immediately adjacent to the third section 84 is the exit end section 86. It defines the exit end 58. The exit end section 86 has a same internal diameter as the third section 84, but as can be seen in FIG. 10, along the outer diameter, there is a radial inward step 88 between the third section 84 and the exit end section 86. The length of the exit end section 86 is less than 15% of the overall length of the outlet tube 80.

Turning again to the pre-cleaner 10 of FIGS. 1-4, it should now be appreciated how the pre-cleaner 10 operates. The pre-cleaner tube assemblies 30 are oriented in the interior 20 of the housing 12 such that each of the first ends 38 of the inlet tubes 32 are at the air inlet 14 of the housing. Each of the exit ends 58 of the outlet tubes 50 is at the air outlet 16 of the housing 12. Each of the slots 48 is oriented toward the debris outlet 18.

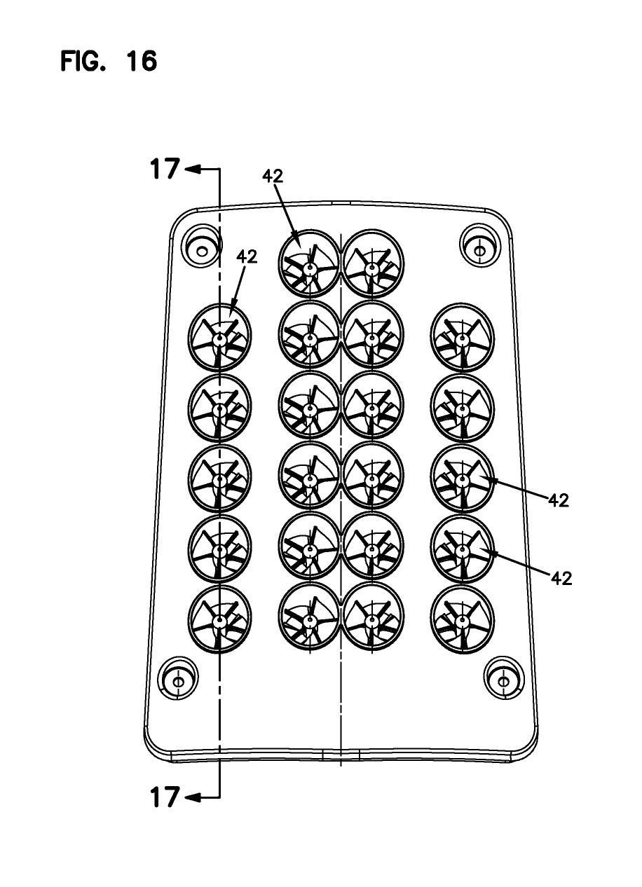

In some preferred embodiments, the housing cover 22 is molded as a single piece to include the outlet tubes 50. This can be seen in FIG. 4. In the embodiment of FIGS. 15-17, to be described below, the housing cover 122 is molded as a single piece to include the inlet tubes 32.

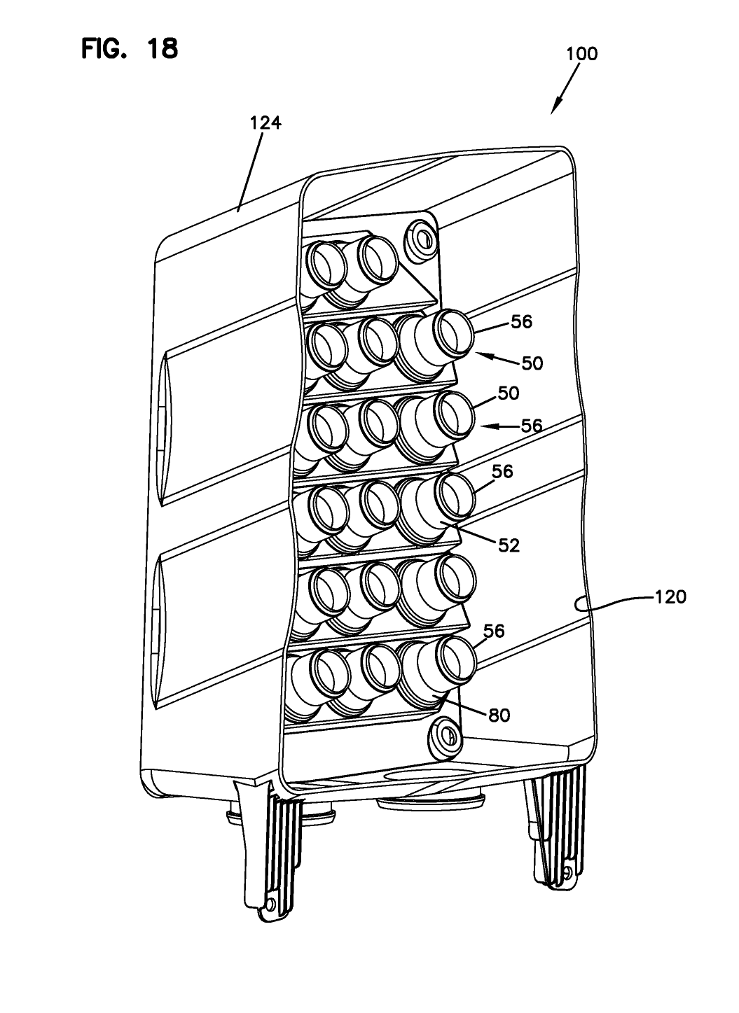

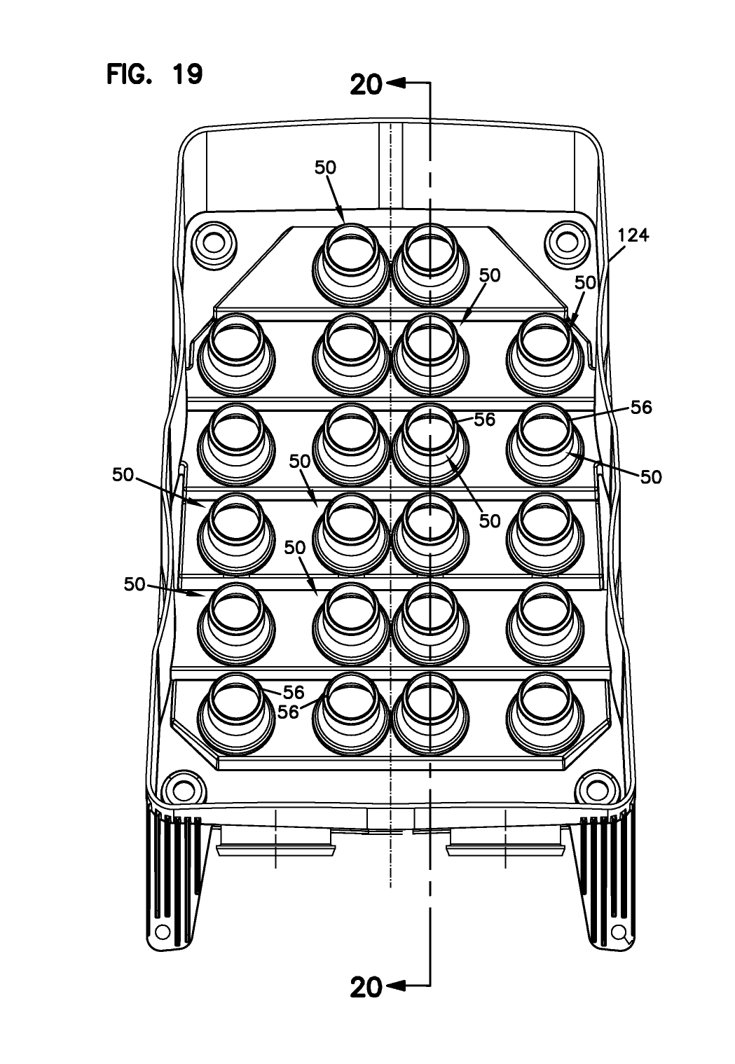

In some preferred embodiments, the housing body 24 is molded as a single molded piece as the inlet tubes 32. In the embodiment of FIGS. 18-21, described below, the housing body 124 is molded as a single molded piece as the outlet tubes 50.

In operation, air to be pre-cleaned is directed into the air inlet 14 of the housing 12 and into the first end 38 of the inlet tubes 32. There is a step of causing the air flowing into the first end 38 of the inlet tubes 32 to swirl by use of the vane arrangement 42. The swirling air then produces centrifugal forces, which will direct at least some debris in a direction toward the inner surface 46 of the inlet tube wall 34. Air is then allowed to flow through the outlet tube 50 by entering through the entrance end 56. The air in the outlet tube 50 then exits the outlet tube 50 through the exit end 58 and then out through the air outlet 16 of the housing 12. At least some of the debris will not flow through the outlet tube 50, but will fall by gravity through the slot 48 and then fall into the debris outlet 18 of the housing.

The pre-cleaner 10 using the pre-cleaner tube assemblies 30 was tested and compared to a standard pre-cleaner. The standard pre-cleaner did not have the ramp 64 on the outlet tube. Other differences included: the standard pre-cleaner had 39 tube assemblies, while the pre-cleaner 10 had 21; and the horizontal and vertical distance center-to-center of the standard was 39 mm and 39 mm, versus the pre-cleaner 10 was 70 mm and 65 mm. The flow through the both the standard pre-cleaner and the pre-cleaner 10 was 27.5 m³/min. The results were as follows:

| | Standard pre-cleaner | Pre-cleaner 10 |
|---|---|---|
| Restriction (mbar) | 6 | 4.3 |
| Water separation (%) | 65.4 | 85.7 |

Thus, from the above, it can be seen that the restriction through the pre-cleaner 10 drops by 28%, from 6 mbar to 4.3 mbar, while the percentage of water separation increases by 31%, from 65.4% to 85.7%, when compared to the standard pre-cleaner.

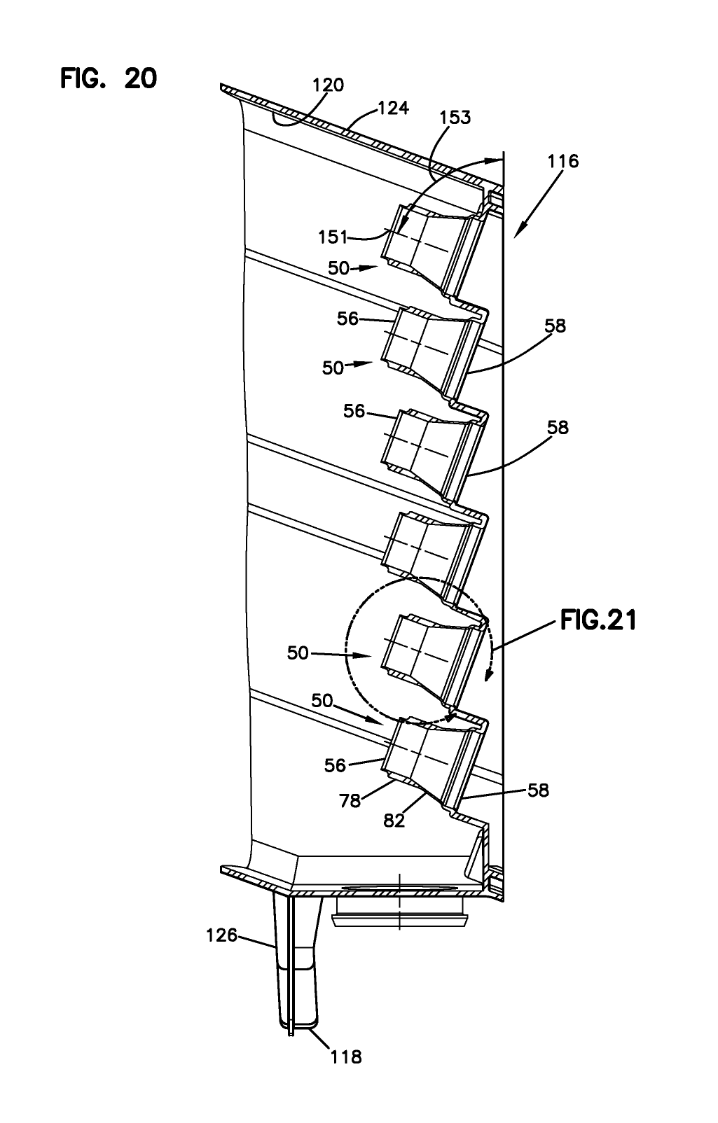

FIGS. 15-21 depict an alternate embodiment of a pre-cleaner 100 (part being shown in FIG. 15 and part being shown in FIG. 18) constructed in accordance with principles of this disclosure. The pre-cleaner 100 includes a housing having an air inlet 114 (FIGS. 15-17), an air outlet 116 (FIG. 20), a debris outlet 118 (FIG. 20), and an interior 120 (FIGS. 18 and 20). The air inlet 114 and air outlet 116 are at opposite sides of the housing.

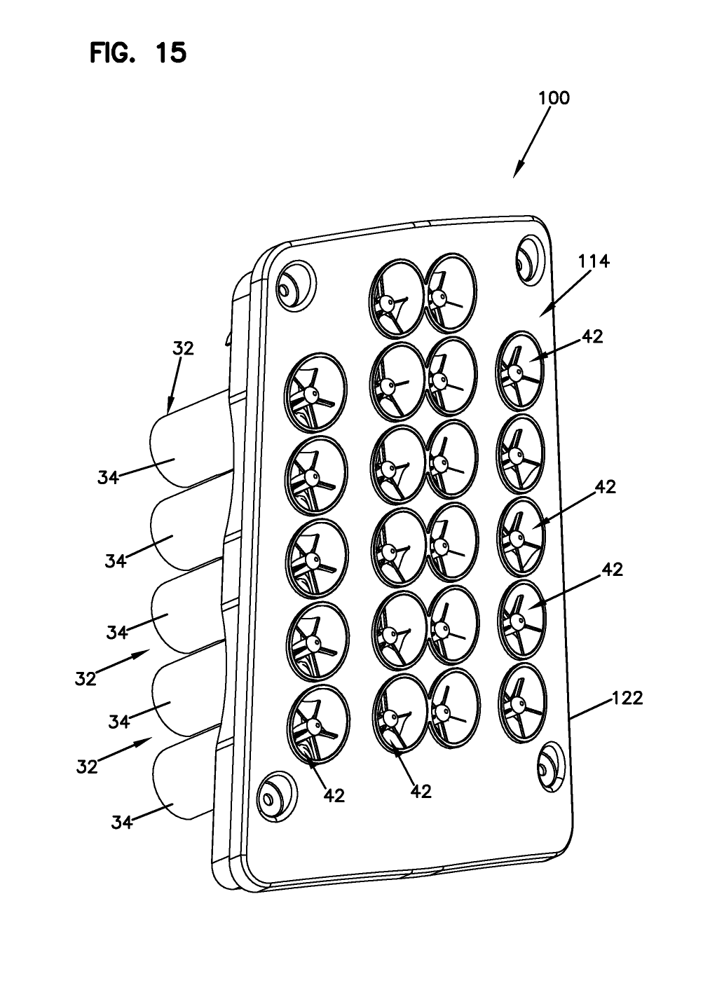

The housing has a cover 122. In this embodiment, as contrasted with the previous embodiment, the cover 122 defines the air inlet 114 of the housing. The housing also includes a housing body 124 (FIGS. 18-20). The cover 122 operably attaches and is securable to the housing body 124, in the same way as the previous embodiment shows the cover 22 secured to the body 24. In this embodiment, the housing body 124 defines the air outlet 116, in contrast to the embodiment of FIGS. 1-14.

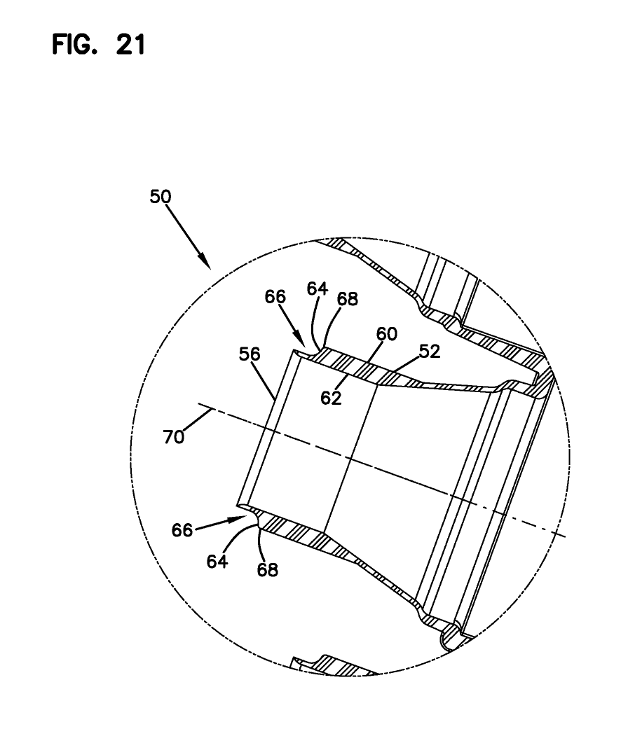

The debris outlet 118 (FIG. 21) is illustrated as a tube 126 extending from the housing body 124. The tube 126 of the debris outlet 118 is in open communication with the interior 120 of the housing. The tube 126 may be closed with an evacuation valve, such as evacuation valve 28 shown in the embodiment of FIGS. 1-14.

In the interior 120 of the housing, the pre-cleaner 110 includes a plurality of pre-cleaner tube assemblies 30 as illustrated previously in FIG. 7. The pre-cleaner tube assemblies 30 are operably oriented in the interior 120 so that air flowing through the air inlet 114 of the housing flows through the pre-cleaner tube assemblies 30, and then the air exiting the housing through the air outlet 116 will exit the pre-cleaner tube assemblies 30. The pre-cleaner tube assemblies 30 remove at least some debris from the air and cause the debris to fall into the debris outlet 118. Operation of the pre-cleaner tube assemblies 30 are the same as described above with respect to the embodiment of FIGS. 1-14.

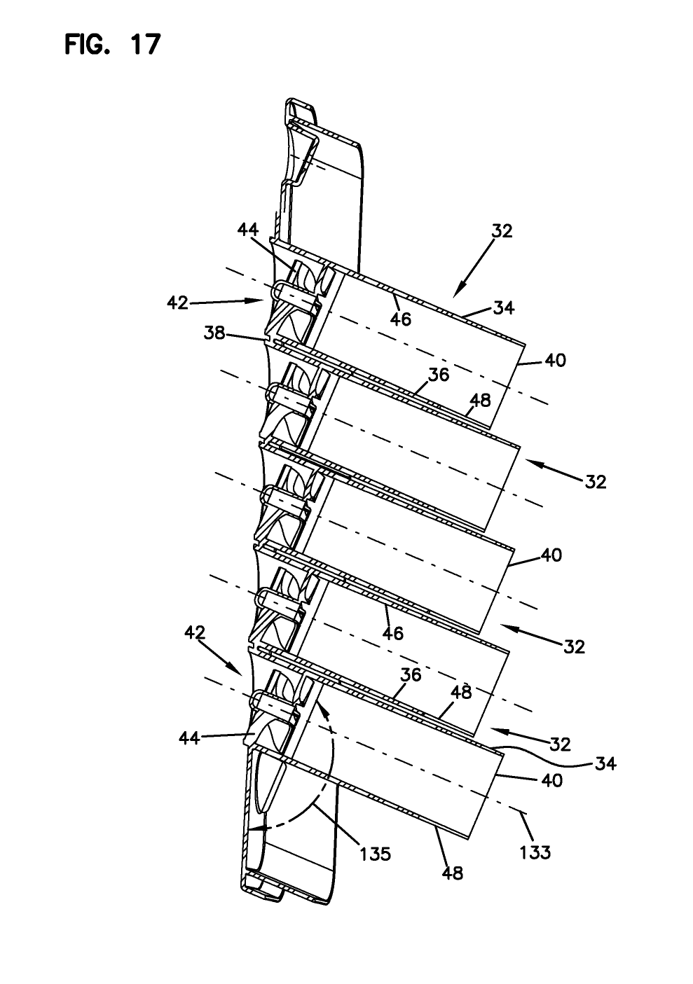

In this embodiment, the inlet tubes 32 of the pre-cleaner tube assembly 30 have a central longitudinal axis 133 (FIG. 17) which is angled at a non-zero and non-perpendicular angle relative a plane containing the air inlet 114. In the previous embodiment, the inlet tube 32 had its central longitudinal axis as generally perpendicular to the plane containing the inlet 14. The angle is shown at reference number 135. Many different angles can be used. For example, the angle 135 can be greater than 45 degrees. The angle 135 can be less than 90 degrees. The angle 135 can be 60-80 degrees. In the embodiment show, the angle 135 is about 70 degrees.

The inlet tube 32 has the same structure as described above with respect to the embodiment of FIGS. 5-7. The description of the inlet tube 32 with respect to the previous embodiment is incorporated herein by reference. The same reference numerals are used for the same parts, and the same description applies.

The pre-cleaner tube assembly 30 includes outlet tube 50, as previously described. In this embodiment, the outlet tube 50 is incorporated within the housing body 124. In FIG. 20, each outlet tube 50 has a central longitudinal axis 151 which is at a non-zero and non-perpendicular angle relative to a plane containing the air outlet 116. The angle is illustrated at reference numeral 153. In general, the angle 153 will be the same as angle 135 to allow the outlet tubes 50 to be received within the inlet tubes 32. The angle 153 can be greater than 45 degrees. The angle 153 can be less than 90 degrees. The angle 153 can be between 60-80 degrees. The angle 153 can be about 70 degrees.

The outlet tube 50 of the embodiment of FIGS. 18-21 is the same as the outlet tube 50 of the previous embodiment, and the description of such is incorporated herein by reference. The same reference numerals are used for the same structure as described for the previous embodiment.

The operation of the pre-cleaner 110 is the same as the operation of the pre-cleaner 10 and as described above.

The above represents example principles of this disclosure. Many embodiments can be made.

1. A pre-cleaner tube assembly comprising:
(a) an inlet tube having an inlet tube wall surrounding an interior volume, and first and second open, opposite ends;
(i) a vane arrangement oriented within the inlet tube wall adjacent to the first open end;
(ii) the inlet tube wall defining a slot adjacent to the second open end;
(b) an outlet tube having an outlet tube wall surrounding an interior volume, an open entrance end and an opposite open exit end;
(i) the outlet tube wall having an exterior and an interior;
(ii) the exterior of the outlet tube wall having a ramp extending upward as the ramp extends from a region adjacent the entrance end toward a remaining portion of the outlet tube wall;
(iii) the outlet tube being oriented in the inlet tube wall interior volume such that the entrance end and over 50% of a length of the outlet tube wall is within the inlet tube wall interior volume.

2. The pre-cleaner tube assembly of claim wherein the exit end of the outlet tube is exterior of the inlet tube wall.

3. The pre-cleaner tube assembly of claim 1 wherein the ramp is on a radius of 1.5-3 mm.

4. The pre-cleaner tube assembly of claim 1 wherein the ramp is on a radius of 2-2.5 mm.

5. The pre-cleaner tube assembly of claim 1, wherein:
(a) the entrance end of the outlet tube is circular with an internal radius and a central axis;
(b) a first distance is defined between the central axis and a radial outermost point of the ramp; and
(c) a ratio of the first distance to the internal radius of the entrance end is between 1.1 and 1.3.

6. The pre-cleaner tube assembly of claim 5, wherein the ratio of the first distance to the internal radius of the entrance end is about 1.2.

7. The pre-cleaner tube assembly of claim 1 wherein at least 75% of a length of the outlet tube wall is within the inlet tube wall interior volume.

8. The pre-cleaner tube assembly of claim 1 wherein the second end of the inlet tube is engaged against the exterior of the outlet tube wall and closer to the exit end of the outlet tube than the entrance end of the outlet tube.

9. The pre-cleaner tube assembly of claim 1 wherein the slot in the inlet tube wall is an open slot extending from the second open end.

10. The pre-cleaner tube assembly of claim 1 wherein the slot in the inlet tube wall extends a length of at least 50% of the length of the outlet tube.

11. The pre-cleaner tube assembly of claim 1, wherein the exit end of the outlet tube has a diameter greater than a diameter of the entrance end of the outlet tube.

12. The pre-cleaner tube assembly of claim 1, wherein the inlet tube wall has a constant outer diameter.

13. A pre-cleaner comprising:
(a) a housing having an air inlet, an opposite air outlet, a debris outlet, and an interior;
(b) a plurality of pre-cleaner tube assemblies according to any one of the preceding claims operably oriented in the interior of the housing such that:
(i) each of the first ends of the inlet tubes are at the air inlet of the housing;
(ii) each of the exits ends of the outlet tube are at the air outlet of the housing; and
(iii) each of the slots is oriented toward the debris outlet.

14. The pre-cleaner of claim 13, wherein the housing includes a cover that is a single molded piece as the inlet tubes.

15. The pre-cleaner of claim 13, wherein the housing includes a housing body that is a single molded piece as the outlet tubes.

16. The pre-cleaner of claim 13, wherein the housing includes a cover that is a single molded piece as the outlet tubes.

17. The pre-cleaner of claim 13, wherein the housing includes a housing body that is a single molded piece as the inlet tubes.

18. The pre-cleaner of claim 13, wherein the inlet tubes have a central longitudinal axis angled relative to the air inlet at a non-zero and non-perpendicular angle.

19. The pre-cleaner of claim 18, wherein the angle of the inlet tube axis relative to the air inlet is at least 45° and less than 90°.

20-23. (canceled)

24. A method of using a pre-cleaner of claim 13, the method comprising:
(a) directing air flow into the air inlet of the housing and into the first end of the inlet tubes;
(b) causing the air flowing into the first end of the inlet tubes to swirl with the vane arrangement;
(c) allowing centrifugal forces to direct at least some debris in a direction toward an inner surface of the inlet tube wall;
(d) allowing the air to flow through the outlet tube and out of the air outlet of the housing; and
(e) allowing at least some of the debris to exit the inlet tube through the slot and fall into the debris outlet of the housing.
